(19) United States
(12) Patent Application Publication
(10) Pub. No.: US 2019/0075482 A1
(43) Pub. Date: Mar. 7, 2019

(54) REFLECTIVE MAPPING OF FLOWS TO RADIO BEARERS

(71) Applicant: Telefonaktiebolaget LM Ericsson (publ), Stockholm (SE)

(72) Inventors: Ann-Christine Eriksson, Enköping (SE); Henrik Enbuske, Stockholm (SE); Henning Wiemann, Aachen (DE)

(73) Assignee: Telefonaktiebolaget LM Ericsson (publ), Stockholm (SE)

(21) Appl. No.: 15/771,015

(22) PCT Filed: Nov. 3, 2017
(86) PCT No.: PCT/SE2017/051096

§ 371 Date: Apr. 25, 2018

Related U.S. Application Data
(60) Provisional application No. 62/417,835, filed on Nov. 4, 2016.

(51) Int. Cl. H04W 28/02; H04W 76/27; H04W 72/12

(52) U.S. Cl. CPC H04W 28/0263; H04W 72/1273; H04W 76/27

(57) ABSTRACT

Systems and methods for reflective mapping of flows to radio bearers are provided. In some embodiments, a method of operation of a radio access node includes determining a flow-to-radio bearer mapping by determining a radio bearer to which to map a flow. The method also includes mapping the flow to the radio bearer according to the flow-to-radio bearer mapping, where the radio bearer is different than a previous radio bearer to which the flow was mapped and transmitting a downlink transmission for the flow on the radio bearer according to the flow-to-radio bearer mapping. The downlink transmission includes a flow identifier of the flow. In this way, a flow may be quickly mapped to another radio bearer for a wireless device. This may be for when the transmission of a flow starts or changes in characteristics. Also, control signaling is reduced between the radio access node and the wireless device.

### RELATED APPLICATIONS

This application claims the benefit of provisional patent application Ser. No. 62/417,835, filed Nov. 4, 2016, the disclosure of which is hereby incorporated herein by reference in its entirety.

### 1. TECHNICAL FIELD

The present disclosure relates to mapping flows to radio bearers.

### 2. BACKGROUND

### 2.1 Technical Background/Existing Technology

In New Radio (NR) Third Generation Partnership Project (3GPP) discussions, Protocol Data Unit (PDU) sessions are established between the User Equipment device (UE) and the Core Network (CN). A UE may have multiple PDU sessions for which a user plane tunnel is established between the CN and the radio network. Each PDU session may include a number of PDU flows. Packets are grouped into “flows” according to filters, e.g., Traffic Flow Templates (TFTs) (5 tuple). Each flow is associated with a “Flow ID.” This “Flow ID” is expected to be included in the packet header and received on the user plane tunnel per PDU session from the CN to the Radio Access Network (RAN) (NG3/NG-u interface (NR)).

The flows are then mapped to data radio bearers in the RAN. The RAN is responsible for the decision of mapping flows to data radio bearers, and multiple flows may be mapped to the same data radio bearer. Also, flows from different PDU sessions may be mapped to the same data radio bearer.

Which flows belong to which data radio bearer needs to be indicated to the UE. This indication may be done using control signaling to the UE, and by marking each user data packet with a flow Identity (ID) and possibly a PDU session ID (or user data tunnel ID) by the RAN in the downlink transmission. In the same way, the UE needs to mark the user data packets in the uplink transmission such that the RAN may map the packets to the correct flow and PDU session towards the CN. Depending on the uniqueness of the PDU session ID and the flow ID, the value range of the identities varies.

In some embodiments, a reflective Quality of Service (QoS) function allows the UE to map the uplink packets to the corresponding flows. Using this function, the UE learns and/or detects the mapping rule between downlink packets and the downlink flow, and creates TFTs (filters) for uplink that can map uplink packets to the same flow in the uplink direction. Thus, there is no explicit Non-Access Stratum (NAS) signaling to the UE required for the configuration of “NAS” uplink filters.

### 3. SUMMARY

### 3.1 Problems With Existing Solutions

At Protocol Data Unit (PDU) session establishment there may be multiple PDU flows included, but not all of the PDU flows will be actively transmitting data immediately. The Radio Access Network (RAN) needs to decide if and how a PDU flow is mapped to a radio bearer. The RAN informs the mapping to the User Equipment device (UE) via control plane signaling. With only control plane signaling to indicate the mapping, if the RAN decides to map a PDU flow not actively transmitting data to a radio bearer or not to map the PDU flow to any radio bearer at all, and later wishes to change to mapping, the RAN needs to do control signaling again to the UE to inform the UE of the change. The RAN may wish to do this re-mapping throughout the life-time of the PDU session and its PDU flows depending on when the PDU flows are active, as well as depending on the characteristics of the data transmission per PDU flow.

Performing this mapping through control signaling between the UE and the RAN may increase the amount of signaling on the control interface. Further, if many flows and radio bearers are being mapped, this may overload the signaling interface. Additionally, this indication of a new mapping may take additional time since the control plane may not be immediately available. Also, if the UE does not correctly receive the control signaling, the mapping intended by the RAN may not be communicated.

### 3.2 Embodiments of the Present Disclosure

Systems and methods for reflective mapping of flows to radio bearers are provided. As used herein, reflective mapping means that a wireless device will detect the mapping rules by inspecting which radio bearer packets a flow is transmitted on in the downlink, and perform the same mapping rule when transmitting packets of the flow in the uplink. In some embodiments, a method of operation of a radio access node includes determining a flow-to-radio bearer mapping by determining a radio bearer to which to map a flow for a wireless device. The method also includes mapping the flow to the radio bearer according to the flow-to-radio bearer mapping, where the radio bearer is different than a previous radio bearer to which the flow was mapped and transmitting a downlink transmission to the wireless device for the flow on the radio bearer according to the flow-to-radio bearer mapping. The downlink transmission includes a flow identifier of the flow. In this way, a flow may be quickly mapped to another radio bearer for a wireless device since the mapping does not need to be signaled through over the control interface. Also, this mapping indication is included with the downlink transmission and does not require an additional transmission to only signal the mapping. The radio access node may determine to change the mapping when the transmission of a flow starts or a flow changes in characteristics. Also, control signaling is reduced between the radio access node and the wireless device since the mapping from flows to radio bearers does not need to be sent via control signaling.

In some embodiments, the flow is a PDU flow. In some embodiments, the method also includes determining a default flow-to-radio bearer mapping. Further, mapping the flow to the radio bearer includes mapping the flow to the radio bearer, where the radio bearer is different than the default flow-to-radio bearer mapping.

In some embodiments, the flow-to-radio bearer mapping is temporary. In some embodiments, the flow-to-radio bearer mapping is part of a two-level mapping including a first mapping from packet to flow and a second mapping of flow to radio bearer. In some embodiments, a flow identifier of the flow is included in a packet header included in the transmission.

In some embodiments, upon the wireless device entering a dormant state, the method includes reverting to the default flow-to-radio bearer mapping. In some embodiments, upon the wireless device entering a dormant state, the method includes keeping the new flow-to-radio bearer mapping.

In some embodiments, the method also includes sending control signaling to the wireless device to change a flow-to-radio bearer mapping for the wireless device. In some embodiments, the control signaling is Radio Resource Control (RRC) signaling.

In some embodiments, the method also includes determining a new flow-to-radio bearer mapping by determining a new radio bearer to which to map the flow for the wireless device and mapping the flow to the new radio bearer according to the new flow-to-radio bearer mapping. The method further includes transmitting a downlink transmission to the wireless device for the flow on the new radio bearer according to the new flow-to-radio bearer mapping.

In some embodiments, the method includes informing the wireless device of the default flow-to-radio bearer mapping.

In some embodiments, the method also includes initiating a switch from the default flow-to-radio bearer mapping and the new flow-to-radio bearer mapping via in-band control information.

In some embodiments, a radio access node for a cellular communications system includes at least one processor and memory. The memory includes instructions executable by the at least one processor whereby the radio access node is operable to determine a flow-to-radio bearer mapping by determining a radio bearer to which to map a flow for a wireless device. The radio access node is also operable to map the flow to the radio bearer according to the flow-to-radio bearer mapping, where the radio bearer is different than a previous radio bearer to which the flow was mapped. The radio access node is further operable to transmit a downlink transmission to the wireless device for the flow on the radio bearer according to the flow-to-radio bearer mapping. The downlink transmission includes a flow identifier of the flow.

In some embodiments, a radio access node for a cellular communications system is adapted to operate according to the methods disclosed herein.

In some embodiments, a method of operation of a wireless device in a cellular communication system includes detecting arrival of a downlink transmission of a flow on a radio bearer which is a flow-to-radio bearer mapping, where the radio bearer is different than a previous radio bearer to which the flow was mapped. The method also includes performing an uplink transmission to a radio access node in the cellular communication system based on the flow-to-radio bearer mapping.

In some embodiments, the flow is a PDU flow. In some embodiments, prior to detecting the arrival of the downlink transmission, the method includes receiving, from the radio access node, an indication of a default flow-to-radio bearer mapping. The detected flow-to-radio bearer mapping is different than the default flow-to-radio bearer mapping.

In some embodiments, the flow-to-radio bearer mapping is temporary. In some embodiments, the flow-to-radio bearer mapping is part of a two-level mapping including a first mapping from packet to flow and a second mapping of flow to radio bearer.

In some embodiments, upon the wireless device entering a dormant state, the method includes reverting to the default flow-to-radio bearer mapping. In some embodiments, upon the wireless device entering a dormant state, the method includes keeping the flow-to-radio bearer mapping.

In some embodiments, the method includes receiving control signaling from the radio access node that indicates to the wireless device to change a flow-to-radio bearer mapping for the wireless device based on detecting arrival of downlink data packets using a new flow-to-radio bearer mapping.

In some embodiments, the method includes receiving control signaling from the radio access node to change a flow-to-radio bearer mapping for the wireless device. In some embodiments, control signaling is RRC signaling.

In some embodiments, the method also includes detecting arrival of a downlink transmission of the flow on a new radio bearer comprising a new flow-to-radio bearer mapping, where the new radio bearer is different than the previous radio bearer to which the flow was mapped. The method includes then performing an uplink transmission to the radio access node based on the new flow-to-radio bearer mapping.

In some embodiments, the method includes receiving an initiation of a switch from the default flow-to-radio bearer mapping and the new flow-to-radio bearer mapping via in-band control information.

In some embodiments, a wireless device in a cellular communication system includes at least one processor and memory. The memory includes instructions executable by the at least one processor whereby the wireless device is operable to detect arrival of a downlink transmission of a flow on a radio bearer indicating a flow-to-radio bearer mapping. The radio bearer is different than a previous radio bearer to which the flow was mapped. The wireless device is also operable to perform an uplink transmission to a radio access node in the cellular communication system based on the flow-to-radio bearer mapping.

In some embodiments, a wireless device for a cellular communications system is adapted to operate according to the methods disclosed herein.

The present disclosure describes a method to apply reflective mapping of PDU flows to radio bearers. Meaning that the RAN may map a PDU flow to any existing radio bearer to a UE, without informing the UE of the mapping rules via control signaling. The UE will detect the mapping rules by inspecting what radio bearer packets of a PDU flow is transmitted on in the downlink, and perform the same mapping rule when transmitting packets of a PDU flow in the uplink. In this way, a flow may be quickly mapped to another radio bearer for a wireless device since the mapping does not need to be signaled through over the control interface. Also, this mapping indication is included with the downlink transmission and does not require an additional transmission to only signal the mapping. The radio access node may determine to change the mapping when the transmission of a flow starts or a flow changes in characteristics. Also, control signaling is reduced between the radio access node and the wireless device since the mapping from flows to radio bearers does not need to be sent via control signaling.

The UE is provided with a default mapping of PDU flows to a radio bearer to be used by the UE for uplink transmission until new mapping rules are detected via downlink packets.

This reflective mapping of PDU flows to radio bearers may be performed independently of whether the Core Network (CN) applies reflective Quality of Service (QoS) rules on the Non-Access Stratum (NAS) layer and on the user plane between the UE and the CN.

At PDU session establishment, all PDU flows may be mapped to a default radio bearer, and later re-mapped to other radio bearers without informing the UE via control signaling.

The RAN may quickly re-map a PDU flow to another existing radio bearer for a UE, when the transmission of a PDU flow starts or changes in characteristics. Control signaling is reduced between the RAN and the UE.

### 4. BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates legacy Quality of Service (QoS) mapping and/or filtering in Third Generation Partnership Project (3GPP) Long Term Evolution (LTE);

FIG. 3 shows the changes expected to QoS mapping and/or filtering in the next generation Core Network (CN) (e.g., for 3GPP Fifth Generation (5G) New Radio (NR));

FIG. 4 depicts a two-step mapping (Non-Access Stratum (NAS): service → flow; AS: flow → Data Radio Bearer (DRB)) according to some embodiments of the present disclosure;

FIG. 5 illustrates the operation of a radio access node according to some embodiments of the present disclosure;

FIG. 6 illustrates the operation of a wireless device according to some embodiments of the present disclosure;

FIGS. 7 and 8 illustrate example embodiments of a wireless device; and

FIGS. 9 through 11 illustrate example embodiments of a network node (e.g., a radio access node).

### 5. DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The present disclosure includes methods to handle the decision and configuration of Protocol Data Unit (PDU) flows related to a PDU session and a User Equipment device (UE) with respect to radio bearers between the Radio Access Network (RAN) and the UE.

The principle is to inform the UE of new PDU flow-to-radio bearer configurations via user data packets, e.g. in the Packet Data Convergence Protocol (PDCP) header, instead of using control plane signaling, i.e. Radio Resource Control (RRC). In some embodiments, another protocol layer above PDCP (e.g., Service Data Adaptation Protocol (SDAP)) that may include this information if configured. Information, e.g. packet marker, of which PDU flow Identity (ID) and PDU session ID data packet belongs to may be included in user data packet headers. By reading this information in downlink data packets, the UE may detect what radio bearer data packets of this combination of PDU flow ID and PDU session ID should be transmitted on in the uplink. There are different methods to convey the packet marker in the radio node and the UE, which is outside the present disclosure.

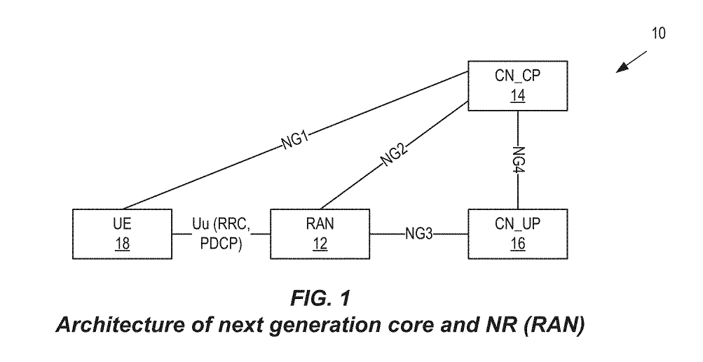

FIG. 1 illustrates one example of a cellular communications system 10 in which embodiments of the present disclosure may be implemented. In this example, the cellular communications system 10 is a Third Generation Partnership Project (3GPP) New Radio (NR) or Fifth Generation (5G) system; however, the present disclosure is not limited thereto. As illustrated, the cellular communications system 10 includes a RAN 12 and a Core Network (CN) including a control plane (CN_CP) 14 and a user plane (CN_UP) 16. The RAN 12 provides radio access to UE(s) 18. The various network nodes are connected by corresponding interfaces (i.e., in this example, the Uu interface, the NG1 interface, the NG2 interface, the NG3 interface, and the NG4 interface, as shown). The RAN 12 includes a number of radio access nodes (e.g., base stations, which in 3GPP NR are referred to as gNBs. The CN includes various core network nodes (e.g., Mobility Management Entities (MMEs), Serving Gateways (S-GWs), Packet Data Network (PDN) Gateways (P-GWs), or the like). As used herein, a UE 18 is any type of wireless communication device such as, for example, a mobile device, a Machine Type Communication (MTC) device, or the like).

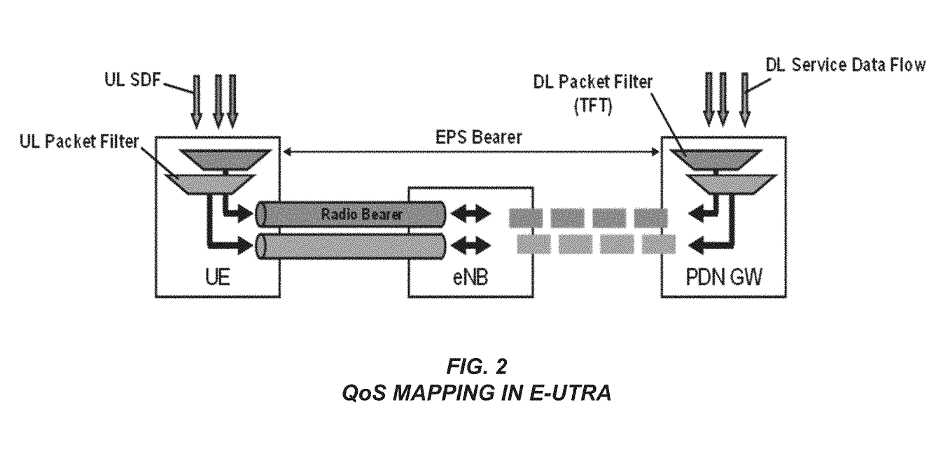

FIG. 2 illustrates legacy Quality of Service (QoS) mapping and/or filtering in 3GPP Long Term Evolution (LTE). Specifically, FIG. 2 depicts the mapping of data (Internet Protocol (IP)) packets to Evolved Packet System (EPS) bearers and to S1 and Data Radio Bearers (DRBs) as it is done in the Evolved Packet Core (EPC). The downlink (DL) and uplink (UL) packet filters on Non-Access Stratum (NAS) level (Traffic Flow Templates (TFTs)) determine (based on source and destination IP Addresses and Port Numbers) in which bearer to carry each packet. As shown in FIG. 2, when downlink packets arrive for a service data flow, they are first passed through a downlink packet filter (e.g., TFT) in the P-GW. The NAS handles the mapping from service data flows to EPS bearers, and AS is responsible for mapping from EPS bearers to DRBs. This mapping is a one-to-one mapping. When the UE has uplink packets for a service data flow, they are similarly passed through an uplink packet filter.

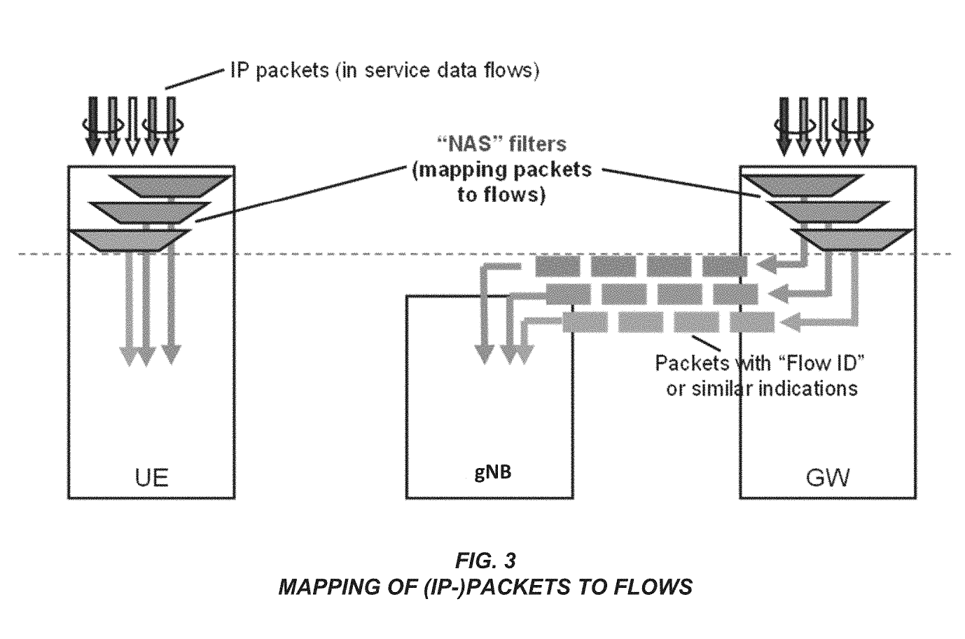

FIG. 3 illustrates embodiments for QoS mapping and/or filtering in the next generation CN (e.g., for 3GPP 5G NR). Instead of mapping IP packets to EPS bearers, in some embodiments, packets may be grouped into flows. In some embodiments, this may be done by packet filters similar to the TFTs defined in EPS, i.e., the next generation CN and the UE could ensure that all packets to and from, for example, the same IP/Port number tuple belong to a “flow.” On their way through the transport network, each packet may be marked with some sort of “Flow ID.” In FIG. 3, these packet filters are denoted as “NAS filters.”

Like in EUTRA/EPC, the CN determines and applies the downlink filters locally and it may configure the UE by means of NAS signaling with a set of UL “NAS filters.”

Besides these explicitly configured uplink packet filters, a reflective QoS function is also possible. As a basic principle, the UE detects which DL packets appear in which DL flow and creates packet filters that identify corresponding UL packets and map those to the same flow in the UL direction. Hence, no explicit NAS signaling to the UE is needed for configuring the “NAS” filters, which has large potential to decrease the control signaling for services where the filter criteria are subject to frequent changes. Explicitly adding and removing filters on port numbers and IP addresses could be avoided by such a mechanism.

Similarly to the PDN Connections in EPS, the next generation CN will support multiple PDU sessions per UE. Each PDU session is mapped to a separate transport network bearer in order to separate them even if the contained packets have an overlapping IP address range. Also, the UE must be able to determine which IP packet belongs to which PDU session in order to route packets correctly. This may also need to be taken into account in the reflective QoS filtering.

As explained above, some embodiments perform the mapping from service data flows to “flows” in the CN and in the UE's NAS layer. Hence, as shown in FIG. 3, the RAN and the UE's Access Stratum (AS) layer remain agnostic to IP/Transport Control Protocol (TCP)/User Datagram Protocol (UDP) port numbers and service data flows. In some embodiments, the RAN binds QoS Flows in the downlink onto access-specific resources based on the NG3 marking and the corresponding QoS characteristics provided via NG2 signaling, also taking into account the NG3 tunnel associated with the downlink packet. In some embodiments, packet filters are not used for binding of QoS Flows onto access-specific resources in RAN.

In some embodiments, the AS in gNB and UE remain agnostic to IP/TCP/UDP port numbers and service data flows.

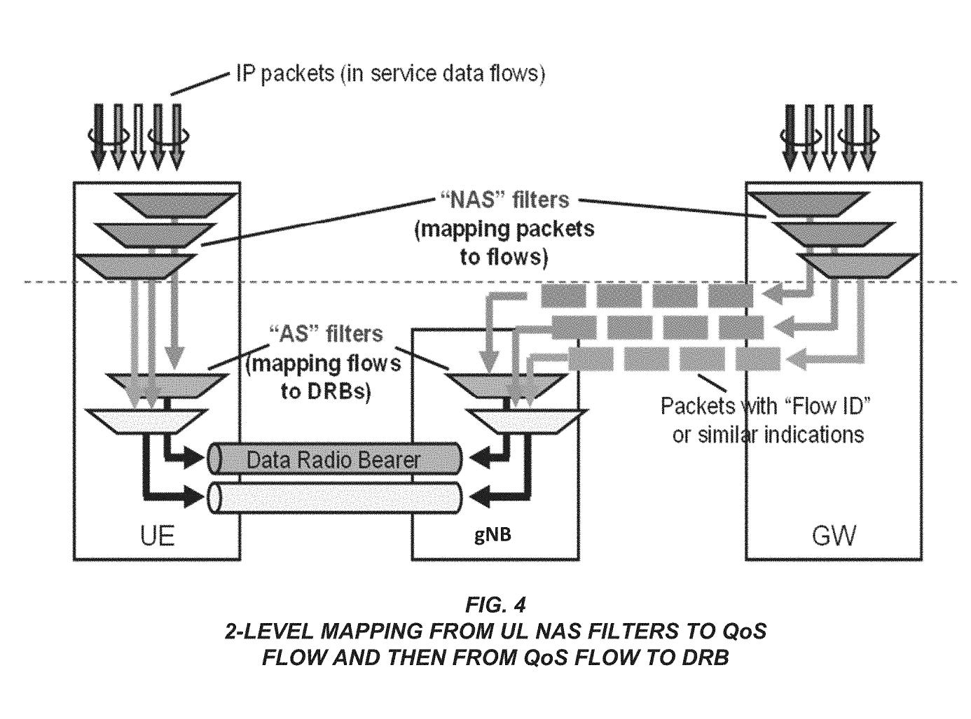

In some embodiments, the “RAN determines the mapping relationship between QoS flow (as determined by the UE in UL or marked by the CN in DL) and DRB for UL and DL.” According to some embodiments of the present disclosure, a two-step mapping (NAS: service → flow; AS: flow → DRB) as depicted in FIG. 4 is proposed herein to enable the RAN to determine the mapping between QoS flow and DRB and to keep the AS agnostic to services.

In FIG. 4, the “AS filters” determine the DRB by just inspecting the “flow ID” of the incoming packet, i.e., the AS layer does not need to be aware of services, traffic-flow-templates, and address/port tuples. The NAS filters, on the other hand, determine the mapping from services to “flow ID” but do not need to be aware of DRBs.

Such a two-step mapping existed also in the EPS QoS concept: NAS handled the mapping from service data flows to EPS bearers and AS was responsible for mapping from EPS bearers to DRBs. However, in EPS, the latter mapping was a pure one-to-one mapping whereas in some embodiments disclosed herein, the mapping can be many-to-one.

The gNB determines the DRB for each flow ID and provides such a configuration to the UE via RRC. This AS configuration is independent of the corresponding NAS mapping (IP packets to “flows”) except that the AS and NAS should use a common set of flow IDs. Hence, the RAN configures the “AS filters” whereas the CN configures the “NAS filters.”

The 2-level mapping from “UL NAS filter to QoS flow” and from “QoS flow to DRB” is well suited for pre-configured QoS.

Thus, a 2-level mapping from “UL NAS filters to Flow” and from “Flow to DRB” for use in, e.g., NR is provided herein. Only the “Flow to DRB” mapping is under responsibility of the access stratum, i.e., UE and gNB.

Besides the pre-configured QoS mapping, in some embodiments, reflective QoS is also supported both on NAS level as well as on AS level. To determine the reflective “AS-filters” at the UE, the gNB must include the flow IDs into the DL packets (e.g., into the PDCP header). Furthermore, the NAS layer uses the flow-ID associated with each IP packet to create uplink “NAS filters” that map the corresponding uplink IP packets to flows. It should be noted that for a certain flow NAS may operate with reflective NAS filters while the RAN provides a configured AS filter or vice versa. In some embodiments, it is not indicated to the RAN whether or not it intends to apply reflective QoS on NAS level.

The flow ID assigned by the CN should not only be used for determining the DRB on the Uu interface but also for QoS handling in the transport network. For example, the “Flow ID” could be used as or mapped to a DiffServ code point in the IP header. DiffServ uses a six-bit differentiated services code point in an eight-bit differentiated services field in the IP header for packet classification purposes. Moreover, the Flow ID in UL may be used by the CN for the purpose of Service Data Flow (SDF) binding verification, i.e. to verify that a Flow ID has not been misused by an SDF. This implies that the gNB should mark uplink packets with the correct “Flow ID” before sending them on the NG3 interface towards the CN. To enable this, UE can include the flow IDs in the UL PDCP headers. Also, in some embodiments, the gNB can include the flow ID in all DL packets so that the UE can determine the necessary “AS filter” and determine the “Flow ID” to include in the UL PDCP header.

Therefore, in some embodiments of the present disclosure, it is proposed herein that UE and gNB include a “Flow ID” into UL and DL PDCP PDU headers respectively.

In some embodiments of the present disclosure, it is also proposed that the UE determines the reflective “AS filter” based on the DL packets received within a DRB and applies those filters for mapping UL Flows to DRBs.

In some embodiments, determining these reflective packet filters is not a one-shot action. The UE continuously monitors the flow ID in DL PDCP packets and updates packet filters accordingly. For example, if the UE observes initially a DL packet with Flow ID X on DRB 1, it creates an AS filter that maps UL packets with Flow ID X to DRB 1, too. But if the UE later observes a DL packet with Flow ID X on DRB 2, it should change the filter for Flow X so that also the UL packets are mapped to DRB 2.

Therefore, in some embodiments, it is proposed herein to allow RAN to re-configure the mapping of PDU flows to radio bearer by sending DL packets on another radio bearer than originally configured. The UE continuously monitors the Flow ID in DL PDCP packets and updates the reflective uplink “AS filters” accordingly. The UE may receive explicit mapping for a flow and also receive such implicit mapping from the DL packets. In some embodiments, the UE uses the most recent flow-to-radio bearer mapping regardless of which way the mapping is determined. In other embodiments, the UE may be configured or instructed to prioritize one or more methods for determining the flow-to-radio bearer mapping. For instance, the UE may be configured or instructed to prioritize RRC signaled flow-to-radio bearer mappings even if a different mapping is determined from received DL packets.

As mentioned above, the embodiments disclosed herein may reduce the signaling overhead but the need to include the flow ID in each PDCP header (or otherwise sent with the packet such as in an SDAP header) increases the user plane protocol overhead. The relative overhead is marginal for large IP packets but could be considered significant for services such as Voice over IP (VoIP).

In some embodiments, this overhead can also be reduced by omitting the flow ID in all but the first DL packet or a certain flow. Or one could compress the flow ID on the radio interface.

There are, however, still cases when the Flow ID does not need to be conveyed: Whenever the gNB configures a dedicated DRB for a Flow (1:1 mapping) and if it configures the Flow to be mapped to the DRB (explicitly configured UL “AS filter”), neither the UE nor the gNB needs to include the flow ID. Since this may be a typical case for IP Multimedia Subsystem (IMS) VoIP as well as for latency critical services where the relative overhead due to the Flow-ID is significant, the gNB should have means to configure for each DRB whether the Flow-ID is conveyed in the PDCP header.

Therefore, in some embodiments, it is proposed that the gNB configures by RRC for each DRB whether or not the UE shall include the Flow-ID in UL PDCP headers.

In some embodiments, there will be both reflective and preconfigured mapping of flows to DRBs. It should also be possible to define a dedicated mapping of flows to DRBs even though the NAS level applies reflective filters only. To ensure the desired behavior, the order in which the UE evaluates the mapping needs to be settled. Hence, in some embodiments of the present disclosure the following is provided.

In some embodiments, if the gNB configures the UE with an uplink “AS filter” that determines the mapping of an uplink flow to a DRB, this mapping overrides any reflective “AS filter” for this flow.

In some embodiments, if the first packet of the flow is UL packet, if no mapping rule is configured in the UE, the packet is sent through default DRB to the network. In some embodiments, specifying this in a more general way, e.g. by not limiting it to a first packet of an UL flow is proposed.

Specifically, in some embodiments, it is proposed that, if an incoming UL packet matches neither a configured nor a reflective UL “AS filter,” the UE shall map that packet to the default DRB.

In some embodiments, the first packet is handled in the case that pre-authorised QoS is configured. With this rule, the UE will follow the configured “AS filter” whenever there is one. If there is no configured AS filter, the UE applies the reflective AS filter as soon as those have been determined based on an observed DL packet. Before that, the UE maps initial UL packets to the default bearer.

In some embodiments, it is proposed that, assuming that there will be very few PDU sessions for a UE and that the establishment and release of PDU sessions will be very static over time, it seems preferable to avoid additional overhead (for signaling the PDU session ID in each PDCP packet) and to allow only traffic of one PDU session to be mapped to a DRB. This approach will also ensure separation of packets that belong to different PDU sessions since there will be separate queues in UE and gNB even if they belong to the same QoS class. In other words, it minimizes the impact that packets of different PDU sessions have on each other. Flows associated with different PDU sessions are mapped to different DRBs.

Systems and methods for reflective mapping of flows to radio bearers are provided. In some embodiments, a method of operation of a radio access node includes determining a flow-to-radio bearer mapping by determining a radio bearer to which to map a flow for a wireless device. The method also includes mapping the flow to the radio bearer according to the flow-to-radio bearer mapping, where the radio bearer is different than a previous radio bearer to which the flow was mapped and transmitting a downlink transmission to the wireless device for the flow on the radio bearer according to the flow-to-radio bearer mapping. The downlink transmission includes a flow identifier of the flow. In this way, a flow may be quickly mapped to another radio bearer for a wireless device. This may be for when the transmission of a flow starts or changes in characteristics. Also, control signaling is reduced between the radio access node and the wireless device.

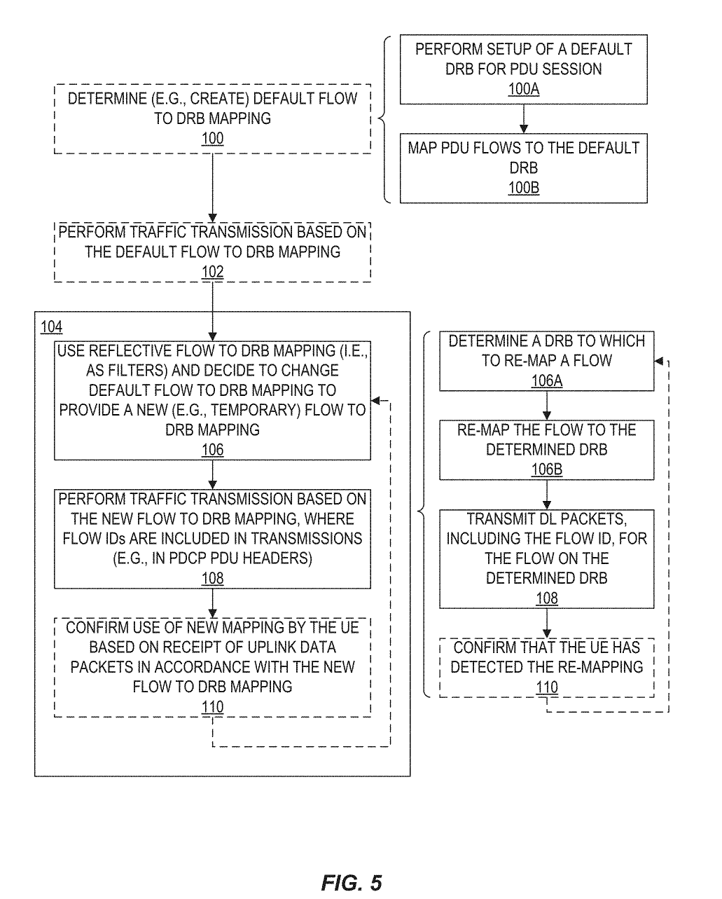

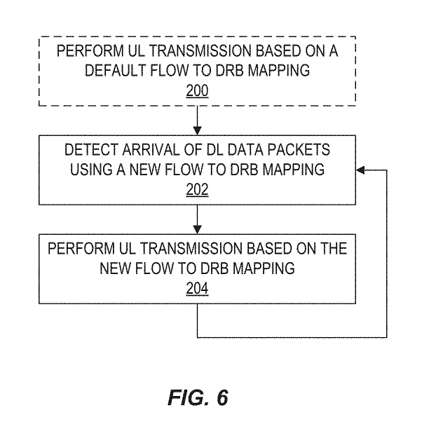

FIGS. 5 and 6 are flow charts that illustrate the operation of a radio access node (e.g., a gNB) and a UE 18, respectively, according to at least some of the embodiments described above. These flow charts also illustrate additional and/or alternative embodiments to those described above. Optional steps are indicated by dashed lines.

As illustrated in FIG. 5, the radio access node determines, or makes, a default mapping of PDU flows to DRBs (step 100). In some embodiments, at PDU establishment, a default flow with default QoS rules is indicated to the UE 18 over NG1 and to the RAN over NG2. The PDU session establishment may also include a number of additional PDU flows with respective QoS rules. While this exemplary embodiment relates to PDU flows, the present disclosure is not limited thereto. The embodiments disclosed herein relate to any type of flow.

In some embodiments, in order to determine the default PDU flow to DRB mapping, the radio access node performs a setup of a default radio bearer for the PDU session (step 100A). The radio node maps all flows included in the PDU session (step 100B). In other words, the default bearer is used as a default mapping of flows to radio bearers (i.e., as a default PDU flow to radio bearer mapping). For example, all flows included in the PDU session, both the default flow as well as any additional flows, are mapped to the default radio bearer. Optionally, the radio node may set up more than the default radio bearer at PDU session establishment and map some PDU flow(s) to the radio bearers by including a flow-to-radio bearer configuration. As another option, the radio node may set up more than the default radio bearer at PDU session establishment for later use, but not include any flow-to-radio bearer configuration to this radio bearer. Thus, all the PDU flows in the PDU session are by default mapped to the default radio bearer.

The radio access node performs traffic transmission (e.g., a DL transmission to a wireless device) based on the default flow to DRB mapping (step 102). In other words, traffic transmission is done based on the default PDU flow-to-radio bearer configuration, except for flows configured to a radio bearer other than the default radio bearer.

The radio node subsequently performs flow-to-radio bearer re-mapping and indicates this re-mapping to the UE 18 by including corresponding flow ID(s) in the DL transmissions (step 104). In some embodiments, the flow-to-radio bearer mapping is temporary. In some embodiments, the flow-to-radio bearer mapping is part of a two-level mapping including a first mapping from packet to flow and a second mapping of flow to radio bearer.

More specifically, the radio node uses reflective flow-to-radio bearer mapping (also referred to as reflective AS filters) and decides to change the default PDU flow-to-radio bearer mapping and/or configuration to provide a new (e.g., temporary) PDU flow-to-radio bearer mapping (i.e., to remap one or some PDU flows to another radio bearer(s)) (step 106). As used herein, re-mapping refers to determining a flow-to-radio bearer mapping that is different than the current or previous flow-to-radio bearer mapping. This may be done due to:

The PDU flow becomes active, i.e. data packets are received by the radio node from either the CN or the UE.

The PDU flow was active, but the traffic characteristics for this PDU flow or another PDU flow have changed.

The radio node has set up more radio bearers or released radio bearers for the UE. This may be decided due to, for example, change in number of UEs and radio bearers in the radio node.

The radio resource usage for a PDU flow in terms of difference in packet forwarding treatment, e.g. packet loss rate, delay budget, or other benefits from a difference in handling of radio bearers.

The radio node then performs DL traffic transmissions based on the new flow-to-radio bearer mapping (step 108). Flow IDs are included in the transmissions (e.g., in PDCP PDU headers). In some embodiments, the radio node confirms that the UE 18 has detected the re-mapping and is using the re-mapping based on receipt of UL data packets from the UE 18 in accordance with the new flow-to-radio bearer mapping (step 110). Steps 106 to 110 are repeated when, e.g., flow-to-radio bearer re-mapping is needed or otherwise desired.

In one example embodiment, step 104 is as follows. The radio node determines a DRB to which to re-map a PDU flow (step 106A), re-maps the PDU flow to the determined DRB (step 106B), and transmits DL packets, including the respective flow ID of the PDU flow, for the PDU flow on the determined DRB (step 108). In other words, the radio node decides to what radio bearer a PDU flow should be re-mapped and sends the next coming downlink data packets on this radio bearer. The UE 18 detects that data packets of the PDU flow arrive on another radio bearer compared to the default PDU flow-to-radio bearer configuration. The UE 18 stores the new (e.g., temporary) PDU flow-to-radio bearer configuration. When the UE 18 has uplink data packets to transmit, the UE sends the data packets on the radio bearer stored in the new PDU flow-to-radio bearer configuration. The radio node confirms that the UE 18 has detected the re-mapping (step 110). In other words, the radio node receives the uplink data packets on the radio bearer the PDU flow was re-mapped to and confirms that the UE 18 has received to change of PDU flow-to-radio bearer configuration. This process may be repeated to perform additional re-mappings.

FIG. 6 illustrates the operation of the UE 18 according to some embodiments of the present disclosure. Again, optional steps are indicated by dashed lines. As illustrated, the UE 18 performs UL transmission(s) based on a default flow-to-radio bearer configuration (step 200). As described above, the UE 18 detects arrival of DL data packets using a new flow-to-radio bearer mapping (step 202). Upon detecting the new flow-to-radio bearer mapping, the UE 18 performs UL transmission based on the new flow-to-radio bearer mapping, as described above (step 204). In some embodiments where the flow is reflective or may be subject to reflective QoS, a per-QoS Flow Reflective QoS Attribute (RQA) is signaled to the gNB. In some embodiments, the UE will not get this information from the CN and thus this information may be signaled to the UE from the gNB. In some embodiments, an indication in the SDAP header (SDAP configured) in the packets is the only indication to the UE that reflective mapping is used. A SDAP header may also be configured when the flow is not being reflectively mapped when there is more than one flow per DRB.

While not necessarily illustrated in FIGS. 5 and 6, some additional embodiments are as follows. Notably, while some embodiments are described separately, it should be appreciated that the embodiments described herein may be combined in any suitable manner.

In some embodiments, the radio node may make further decisions to change also the new (temporary) PDU flow-to-radio bearer configuration to new temporary PDU flow-to-radio bearer configurations. Thus, for example, the procedure of step 104 may be repeated.

In some embodiments, the UE 18 may go into RAN dormant state, e.g. RRC inactive, and keep the PDU session including PDU flows. All relations on the NGx interfaces, including the user plane tunnel on NG3, are kept. The radio node also keeps the UE context. At this stage the PDU flow-to-radio bearer configuration may either:

Be reverted to the initial PDU flow-to-radio bearer configuration decided at PDU session establishment, or

Be kept as the latest temporary PDU flow-to-radio bearer configuration.

In some embodiments, at mobility of the UE 18 to another radio node (e.g., a handover from a source radio node to a target radio node), the new radio node may either revert to default flow-to-radio bearer mapping/configuration, be informed by the previous radio node of what flow-to-radio bearer mapping/configuration is used, or decide upon a new PDU flow-to-radio bearer mapping/configuration. The procedure is similar to PDU session establishment in steps 100-102 above. After that the radio node may decide to change to temporary PDU flow-to-radio bearer configurations as in step 104 above. This information may need to be shared between the source radio node and the target radio node. Also, after mobility, the new radio node may receive UL transmissions on radio bearers for one or more flows. The new radio node may similarly reflectively map these flows to the radio bearers used by the UE 18.

In some embodiments, if dual connectivity is used and the UE 18 is connected using two legs, one leg to each radio node, each radio node is responsible for respective default and new (temporary) PDU flow-to-radio bearer configurations. Again, this information may need to be shared between the two radio nodes. Also, if a flow includes transmissions on both legs, the other radio node may receive UL transmissions on radio bearers for one or more flows. The other radio node may similarly reflectively map these flows to the radio bearers used by the UE 18.

In some embodiments, the radio node may at all times use the control signaling option to change a PDU flow-to-radio bearer configuration. This may for example be used in case the radio node detects that the UE 18 has not received the new PDU flow-to-radio bearer configuration via reading the user data packets.

In some embodiments, the radio node may want to change the packet marker. For example, the radio node may change the information in a user data packet regarding which PDU flow ID and PDU session ID the user data packet belongs to. This may be done by including both the old and the new packet marker in the packet header of the downlink user data packets.

In some embodiments, the UE 18 may also be informed by the radio node of the default PDU flow-to-radio bearer configuration via control signaling, e.g. RRC, and store the default configuration.

In some embodiments, the switch between default and new (temporary) PDU flow to radio bearer may also be initiated by other in-band control information, e.g. Medium Access Control (MAC) Control Element (CE) or other, for example where a configuration is to be changed or reverted, but where no PDU is sent over the other radio bearer.

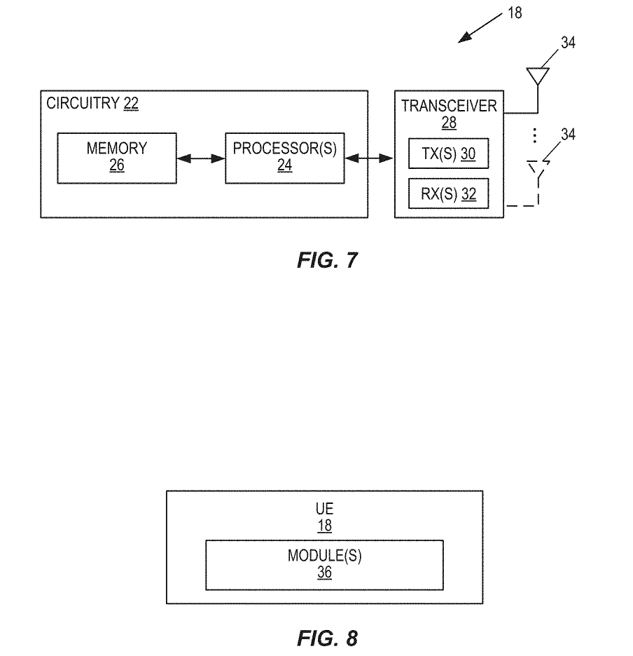

FIG. 7 is a schematic block diagram of the UE 18 (or more generally a wireless device) according to some embodiments of the present disclosure. As illustrated, the UE 18 includes circuitry 22 comprising one or more processors 24 (e.g., Central Processing Units (CPUs), Application Specific Integrated Circuits (ASICs), Field Programmable Gate Arrays (FPGAs), and/or the like) and memory 26. The UE 18 also includes one or more transceivers 28 each including one or more transmitter 30 and one or more receivers 32 coupled to one or more antennas 34. In some embodiments, the functionality of the UE 18 described above may be fully or partially implemented in software that is, e.g., stored in the memory 26 and executed by the processor(s) 24.

In some embodiments, a computer program including instructions which, when executed by at least one processor, causes the at least one processor to carry out the functionality of the UE 18 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the UE 18 (or more generally a wireless device) according to some other embodiments of the present disclosure. The UE 18 includes one or more modules 36, each of which is implemented in software. The module(s) 36 provide the functionality of the UE 18 described herein.

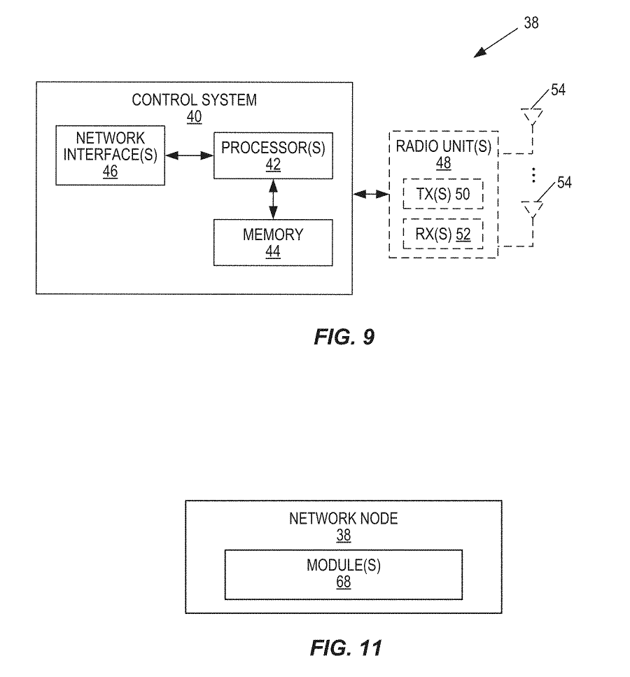

FIG. 9 is a schematic block diagram of a network node 38 (e.g., a gNB) according to some embodiments of the present disclosure. As illustrated, the network node 38 includes a control system 40 that includes circuitry comprising one or more processors 42 (e.g., CPUs, ASICs, FPGAs, and/or the like) and memory 44. The control system 40 also includes a network interface 46. In embodiments in which the network node 38 is a radio access node, the network node 38 also includes one or more radio units 48 that each include one or more transmitters 50 and one or more receivers 52 coupled to one or more antennas 54. In some embodiments, the functionality of the network node 38 (e.g., the functionality of the radio node or gNB) described above may be fully or partially implemented in software that is, e.g., stored in the memory 44 and executed by the processor(s) 42.

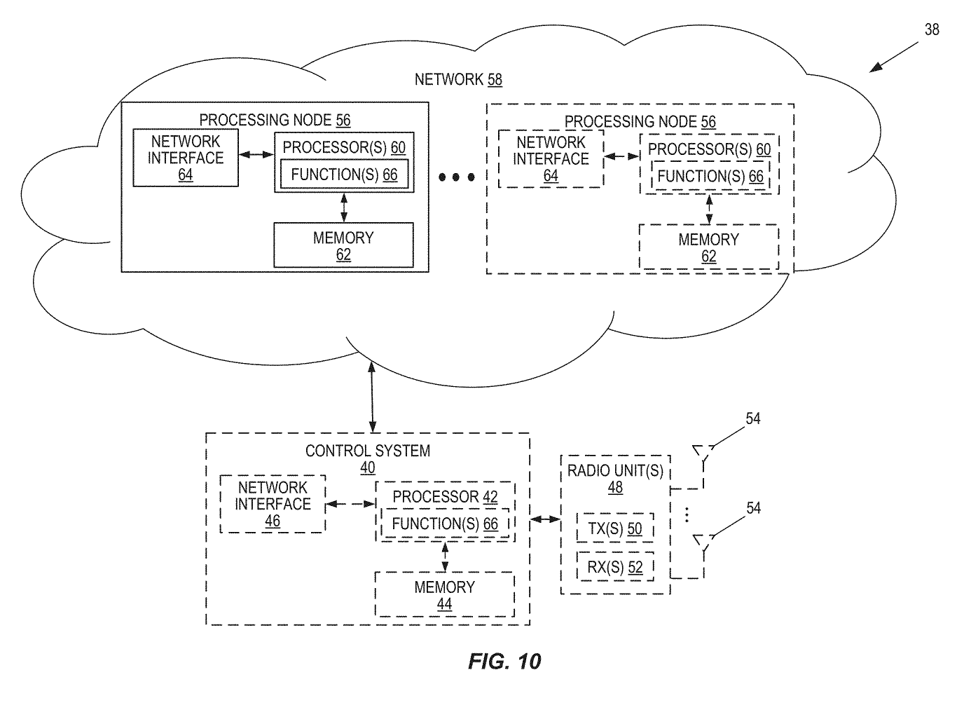

FIG. 10 is a schematic block diagram that illustrates a virtualized embodiment of the network node 38 (e.g., the radio access node) according to some embodiments of the present disclosure. As used herein, a “virtualized” network node 38 is a network node 38 in which at least a portion of the functionality of the network node 38 is implemented as a virtual component (e.g., via a virtual machine(s) executing on a physical processing node(s) in a network(s)). As illustrated, the network node 38 optionally includes the control system 40, as described with respect to FIG. 9. In addition, if the network node 38 is the radio access node, the network node 38 also includes the one or more radio units 48, as described with respect to FIG. 9. The control system 40 (if present) is connected to one or more processing nodes 56 coupled to or included as part of a network(s) 58 via the network interface 46. Alternatively, if the control system 40 is not present, the one or more radio units 48 (if present) are connected to the one or more processing nodes 56 via a network interface(s). Alternatively, all of the functionality of the network node 38 described herein may be implemented in the processing nodes 56 (i.e., the network node 38 does not include the control system 40 or the radio unit(s) 48). Each processing node 56 includes one or more processors 60 (e.g., CPUs, ASICs, FPGAs, and/or the like), memory 62, and a network interface 64.

In this example, functions 66 of the network node 38 described herein are implemented at the one or more processing nodes 56 or distributed across the control system 40 (if present) and the one or more processing nodes 56 in any desired manner. In some particular embodiments, some or all of the functions 66 of the network node 38 described herein are implemented as virtual components executed by one or more virtual machines implemented in a virtual environment(s) hosted by the processing node(s) 56. As will be appreciated by one of ordinary skill in the art, additional signaling or communication between the processing node(s) 56 and the control system 40 (if present) or alternatively the radio unit(s) 48 (if present) is used in order to carry out at least some of the desired functions. Notably, in some embodiments, the control system 40 may not be included, in which case the radio unit(s) 48 (if present) communicates directly with the processing node(s) 56 via an appropriate network interface(s).

In some embodiments, a computer program including instructions which, when executed by at least one processor, causes the at least one processor to carry out the functionality of the network node 38 or a processing node 56 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the network node 38 (e.g., the radio node or gNB) according to some other embodiments of the present disclosure. The network node 38 includes one or more modules 68, each of which is implemented in software. The module(s) 68 provide the functionality of the network node 38 described herein.

### EXAMPLE EMBODIMENTS

While not being limited thereto, some example embodiments of the present disclosure are provided below.

1. A method of operation of a radio access node, comprising:
determining (106) a radio bearer to which to re-map a flow for a wireless device (18);
re-mapping (106B) the flow to the radio bearer; and
transmitting (108) a downlink transmission to the wireless device (18) for the flow on the radio bearer, the downlink transmission comprising a flow identifier of the flow.

2. The method of embodiment 1 wherein the flow is a PDU flow.

3. The method of embodiment 1 or 2 further comprising determining (100) a default flow-to-radio bearer mapping, wherein re-mapping (106B) the flow to the radio bearer results in a new flow-to-radio bearer mapping.

4. The method of embodiment 3 wherein the new flow-to-radio bearer mapping is temporary.

5. The method of any one of embodiments 1 to 4 wherein the flow-to-radio bearer mapping is part of a two-level mapping comprising a first mapping from packet to flow and a second mapping of flow to radio bearer.

6. The method of any one of embodiments 1 to 5 further comprising, upon the wireless device (18) entering a dormant state, reverting to a default flow-to-radio bearer mapping.

7. The method of any one of embodiments 1 to 5 further comprising, upon the wireless device (18) entering a dormant state, keeping the new flow-to-radio bearer mapping.

8. The method of any one of embodiments 1 to 7 further comprising sending control signaling to the wireless device (18) to change a flow-to-radio bearer mapping for the wireless device (18).

9. The method of any one of embodiments 1 to 8 further comprising informing the wireless device (18) of a default flow-to-radio bearer mapping.

10. The method of any one of embodiments 1 to 9 further comprising initiating a switch from the default flow-to-radio bearer mapping and the new flow-to-radio bearer mapping via in-band control information.

11. A radio access node for a cellular communications system (10) adapted to operate according to the method of any one of embodiments 1 to 10.

12. A method of operation of a wireless device (18) in a cellular communications system (10), comprising:
detecting (202) arrival of downlink data packets using a new flow-to-radio bearer mapping (202); and
performing (204) uplink transmission based on the new flow-to-radio bearer mapping.

13. The method of embodiment 12 wherein the flow is a PDU flow.

14. The method of embodiment 12 or 13 further comprising receiving, from a radio access node, an indication of a default flow-to-radio bearer mapping, wherein the new flow-to-radio bearer mapping is different than the default flow-to-radio bearer mapping.

15. The method of any one of embodiments 12 to 14 wherein the new flow-to-radio bearer mapping is temporary.

16. The method of any one of embodiments 12 to 15 wherein the new flow-to-radio bearer mapping is part of a two-level mapping comprising a first mapping from packet to flow and a second mapping of flow to radio bearer.

17. The method of any one of embodiments 12 to 16 further comprising, upon the wireless device (18) entering a dormant state, reverting to a default flow-to-radio bearer mapping.

18. The method of any one of embodiments 12 to 16 further comprising, upon the wireless device (18) entering a dormant state, keeping the new flow-to-radio bearer mapping.

19. The method of any one of embodiments 12 to 18 further comprising receiving control signaling from a radio access node that indicates to the wireless device (18) to change a flow-to-radio bearer mapping for the wireless device (18) based on detecting (202) arrival of downlink data packets using a new flow-to-radio bearer mapping (202).

20. The method of any one of embodiments 12 to 19 further comprising receiving an initiation of a switch from the default flow-to-radio bearer mapping and the new flow-to-radio bearer mapping via in-band control information.

21. A wireless device (18) adapted to operate according to the method of any one of embodiments 12 to 20.

The following acronyms are used throughout this disclosure.

3GPP Third Generation Partnership Project

5G Fifth Generation

AS Access Stratum

ASIC Application Specific Integrated Circuit

CE Control Element

CN Core Network

CPU Central Processing Unit

DL Downlink

DRB Data Radio Bearer

EPC Evolved Packet Core

EPS Evolved Packet System

EUTRA Evolved Universal Terrestrial Radio Access

FPGA Field Programmable Gate Array

gNB Fifth Generation New Radio Base Station

ID Identity

IMS Internet Protocol Multimedia Subsystem

IP Internet Protocol

LTE Long Term Evolution

MAC Medium Access Control

MME Mobility Management Entity

MTC Machine Type Communication

NAS Non-Access Stratum

NR New Radio

PDCP Packet Data Convergence Protocol

PDN Packet Data Network

PDU Protocol Data Unit

P-GW Packet Data Network Gateway

QoS Quality of Service

RAN Radio Access Network

RQA Reflective QoS Attribute

RRC Radio Resource Control

SDAP Service Data Adaptation Protocol

SDF Service Data Flow

S-GW Serving Gateway

TCP Transport Control Protocol

TFT Traffic Flow Template

UDP User Datagram Protocol

UE User Equipment

UL Uplink

VoIP Voice over Internet Protocol

Those skilled in the art will recognize improvements and modifications to the embodiments of the present disclosure. All such improvements and modifications are considered within the scope of the concepts disclosed herein and the claims that follow.

1. A method of operation of a radio access node, comprising:
determining a flow-to-radio bearer mapping by determining a radio bearer to which to map a flow for a wireless device;
mapping the flow to the radio bearer according to the flow-to-radio bearer mapping, where the radio bearer is different than a previous radio bearer to which the flow was mapped; and
transmitting a downlink transmission to the wireless device for the flow on the radio bearer according to the flow-to-radio bearer mapping, the downlink transmission comprising a flow identifier of the flow.

2-13. (canceled)

14. A radio access node for a cellular communications system, comprising:
at least one processor;
memory comprising instructions executable by the at least one processor whereby the radio access node is operable to:
determine a flow-to-radio bearer mapping by determining a radio bearer to which to map a flow for a wireless device;
map the flow to the radio bearer according to the flow-to-radio bearer mapping, where the radio bearer is different than a previous radio bearer to which the flow was mapped; and
transmit a downlink transmission to the wireless device for the flow on the radio bearer according to the flow-to-radio bearer mapping, the downlink transmission comprising a flow identifier of the flow.

15. The radio access node of claim 14 wherein the flow is a Protocol Data Unit, PDU, flow.

16. The radio access node of claim 14 further operable to:
determine a default flow-to-radio bearer mapping; and
wherein, mapping the flow to the radio bearer, where the radio bearer is different than a previous radio bearer to which the flow was mapped comprises being operable to map the flow to the radio bearer, where the radio bearer is different than the default flow-to-radio bearer mapping.

17. The radio access node of claim 16 wherein the flow-to-radio bearer mapping is temporary.

18. The radio access node of claim 14 wherein the flow-to-radio bearer mapping is part of a two-level mapping comprising a first mapping from packet to flow and a second mapping of flow to radio bearer.

19. The radio access node of claim 14 further operable to:
upon the wireless device entering a dormant state, revert to the default flow-to-radio bearer mapping.

20. The radio access node of claim 14 further operable to:
upon the wireless device entering a dormant state, keep the new flow-to-radio bearer mapping.

21. The radio access node of claim 14 further operable to:
send control signaling to the wireless device to change a flow-to-radio bearer mapping for the wireless device.

22. The radio access node of claim 21 wherein sending control signaling to the wireless device comprises being operable to send Radio Resource Control, RRC, signaling to the wireless device to change the flow-to-radio bearer mapping for the wireless device.

23. The radio access node of claim 21 further operable to:
determine a new flow-to-radio bearer mapping by determining a new radio bearer to which to map the flow for the wireless device;
map the flow to the new radio bearer according to the new flow-to-radio bearer mapping; and
transmit a downlink transmission to the wireless device for the flow on the new radio bearer according to the new flow-to-radio bearer mapping.

24. The radio access node of claim 14 further operable to:
inform the wireless device of the default flow-to-radio bearer mapping.

25. The radio access node of claim 14 further operable to:
initiate a switch from the default flow-to-radio bearer mapping and the new flow-to-radio bearer mapping via in-band control information.

26. The radio access node of claim 14 wherein the flow identifier of the flow is included in a packet header included in the downlink transmission.

27. (canceled)

28. A method of operation of a wireless device in a cellular communications system, comprising:
detecting arrival of a downlink transmission of a flow on a radio bearer indicating a flow-to-radio bearer mapping, where the radio bearer is different than a previous radio bearer to which the flow was mapped; and
performing an uplink transmission to a radio access node in the cellular communications system based on the flow-to-radio bearer mapping.

29-40. (canceled)

41. A wireless device in a cellular communications system, comprising:
at least one processor;
memory comprising instructions executable by the at least one processor whereby the wireless device is operable to:
detect arrival of a downlink transmission of a flow on a radio bearer indicating a flow-to-radio bearer mapping, where the radio bearer is different than a previous radio bearer to which the flow was mapped; and
perform an uplink transmission to a radio access node in the cellular communications system based on the flow-to-radio bearer mapping

42. The wireless device of claim 41 wherein the flow is a Protocol Data Unit, PDU, flow.

43. The wireless device of claim 41 further comprising:
prior to detecting the arrival of the downlink transmission, receiving, from the radio access node, an indication of a default flow-to-radio bearer mapping;
wherein the detected flow-to-radio bearer mapping is different than the default flow-to-radio bearer mapping.

44. The wireless device of claim 41 wherein the flow-to-radio bearer mapping is temporary.

45. The wireless device of claim 41 wherein the flow-to-radio bearer mapping is part of a two-level mapping comprising a first mapping from packet to flow and a second mapping of flow to radio bearer.

46. The wireless device of claim 41 further comprising:
upon the wireless device entering a dormant state, reverting to the default flow-to-radio bearer mapping.

47. The wireless device of claim 41 further comprising:
upon the wireless device entering a dormant state, keeping the detected flow-to-radio bearer mapping.

48. The wireless device of claim 45 further comprising:
receiving control signaling from a radio access node that indicates to the wireless device to change a flow-to-radio bearer mapping for the wireless device based on detecting arrival of downlink data packets using a new flow-to-radio bearer mapping.

49. The wireless device of claim 43 further comprising:
receiving control signaling from the radio access node to change a flow-to-radio bearer mapping for the wireless device.

50. The wireless device of claim 48 wherein receiving control signaling comprises receiving Radio Resource Control, RRC, signaling from the radio access node.

51. The wireless device of claim 49 further comprising:
detecting arrival of a downlink transmission of the flow on a new radio bearer comprising a new flow-to-radio bearer mapping, where the new radio bearer is different than the previous radio bearer to which the flow was mapped; and
performing an uplink transmission to the radio access node based on the new flow-to-radio bearer mapping.

52. The wireless device of claim 41 further comprising:
receiving an initiation of a switch from the default flow-to-radio bearer mapping and the new flow-to-radio bearer mapping via in-band control information.

53. The wireless device of claim 41 wherein a flow identifier of the flow is included in a packet header included in the downlink transmission.

54. (canceled)
